(19) United States
(12) Patent Application Publication
(10) Pub. No.: US 2013/0121463 A1
(43) Pub. Date: May 16, 2013

(54) METHOD AND APPARATUS FOR IDENTIFYING AUTHENTICITY OF AN OBJECT

(71) Applicants: Ivan N. Nesch, Crown Point, IN (US); Toshko D. Tzvetkov, Valparaiso, IN (US); Daniel P. Fogarty, Chesterson, IN (US); Benjamin J. Reinhart, Highland, IN (US)

(72) Inventors: Ivan N. Nesch, Crown Point, IN (US); Toshko D. Tzvetkov, Valparaiso, IN (US); Daniel P. Fogarty, Chesterson, IN (US); Benjamin J. Reinhart, Highland, IN (US)

(21) Appl. No.: 13/663,120

(22) Filed: Oct. 29, 2012

Related U.S. Application Data
(60) Provisional application No. 61/552,860, filed on Oct. 28, 2011.

(51) Int. Cl. G01N 23/04

(52) U.S. Cl. 378/62

(57) ABSTRACT

An apparatus and method for applying x-ray absorption, refraction, and/or scatter detection methods to authenticate objects. The invention can be used for the authentication of any object, such as, without limitation, artwork, antiques, currency, shipped materials, etc., by the application of a detection material that is detectable by applying x-rays. The detection material is imbedded within the object, or otherwise invisible to the human eye, IR, UV, and conventional x-ray radiography techniques. The method of this invention is particularly useful in security applications, such as for verifying the authenticity of identification documents like passports and similar identification cards.

### CROSS REFERENCE TO RELATED APPLICATION

This application claims the benefit of U.S. Provisional Patent Application, Ser. No. 61/552,860, filed on 28 Oct. 2011. The co-pending Provisional Application is hereby incorporated by reference herein in its entirety and is made a part hereof, including but not limited to those portions which specifically appear hereinafter.

### FIELD OF THE INVENTION

The invention relates to identifying the authenticity of an object using x-rays. More specifically, the invention utilizes the absorption, refraction, and/or scatter properties of a detection material and/or pattern on and/or embedded into an object to detect the presence of the detection material or pattern in the object, for comparing the detection to a prerecorded pattern to confirm the authenticity of the detection and the object.

### SUMMARY OF THE INVENTION

The method of this invention applies x-ray absorption, refraction, and/or scatter detection methods to authenticate objects. The method of this invention is particularly useful in security applications, such as for verifying the authenticity of identification documents like passports and similar identification cards. The invention can be used for the authentication of any object, such as, without limitation, artwork, antiques, currency, shipped materials, etc., by the application of a detection material that is detectable by applying x-rays.

In one embodiment of this invention, a method for authenticating an object includes steps of providing the object with a detection material that is indistinguishable from the object by the human eye, traversing collimated x-ray radiation through the object, detecting x-ray radiation exiting the object, recording a pattern of the detected x-ray radiation exiting the object, and confirming the presence of the detection material in the recorded pattern. The invention also includes an apparatus for implementing the method. The apparatus can include an x-ray source, such as a collimated x-ray emitter, and an x-ray detector. The detector desirable includes or is in combination with a recording device with a processor and a recordable medium for recording and/or displaying the object detection material.

In one embodiment, the method includes selecting traversed x-ray radiation through the object within a predetermined angular acceptance along a predetermined angle, such as using an analyzer crystal. In one embodiment, the method includes comparing the recorded pattern of detected x-rays exiting the object containing the combined detection material within a predetermined angular acceptance along a predetermined angle to a previously recorded pattern of the detection material.

A final image provided by the method and apparatus of this invention can be obtained with a single image using an analyzer crystal. The method can further capture at least two images at different points of a rocking curve of the analyzer crystal and combine the at least two images, using a data processor, to construct a final image. In some embodiments of this invention, two, three, or more than three images are combined to form a final image. The different images are desirably captured at different locations of the rocking curve.

The detection material can be applied on or embedded in the object. In one embodiment, the detection material comprises a predetermined pattern. The detection material can include a detection pattern selected from an alpha-numeric code, a graphic pattern, a fingerprint pattern, a barcode, or combinations thereof. The detection material is desirably also indistinguishable from an object matrix when inspected by detection techniques, such as visible light, radiowave, ultrasound, and/or conventional x-ray.

In one embodiment, the method includes: producing x-rays; collimating the x-rays in at least one plane; selecting x-rays exiting the object containing the detection material within a predetermined angular acceptance along a predetermined angle; detecting selected x-rays exiting the object containing the detection material within the predetermined angular acceptance along the predetermined angle by an x-ray detector; recording a pattern of the detected x-rays exiting the object containing the detection material, and comparing the recorded pattern of detected x-rays exiting the object containing the detection material to a previously recorded pattern of the detection material. In one embodiment, the method includes collimating the x-rays within an angular tolerance of less than 90 milliradians in at least one plane.

### BRIEF DESCRIPTION OF THE DRAWINGS

FIG. 1 generally illustrates a DEXI apparatus according to one embodiment of this invention.

FIG. 2 representatively illustrates a detection apparatus according to one embodiment of this invention.

FIG. 3 illustrates images of a portion of an example identification card using conventional radiography and DEXI imaging techniques according to one embodiment of this invention.

### DETAILED DESCRIPTION OF THE INVENTION

The present invention provides a device and method for identifying the authenticity of an object using x-rays. The method of this invention includes applying a detection material, such as in a predetermined pattern, to an object. The detection material can be applied on or in the object, such as on a surface of the object or within or between substrates of the object. In one embodiment of this invention, the detection material is applied in a, preferably unique, detection pattern, such as, without limitation, an alpha-numeric code, a graphical pattern, a “fingerprint” pattern, and/or a barcode. The detection material is invisible to the naked eye under the visible light spectrum, and desirably not detectable by common detection techniques such as IR or UV detection, but detectable using x-ray detection based upon x-ray absorption, refraction, and/or scattering.

One embodiment of the invention includes a method for confirming an authenticity of an object. The method includes combining an object with a detection material, producing x-rays, collimating the x-rays at least in one plane, traversing the collimated x-rays through the object containing the combined detection material, selecting x-rays exiting the object containing the combined detection material within a predetermined angular acceptance along a predetermined angle, detecting selected x-rays exiting the object containing the combined detection material within the predetermined angular acceptance along the predetermined angle by an x-ray detector, recording a pattern of the detected x-ray exiting the object containing the combined detection material within a predetermined angular acceptance along a predetermined angle by an x-ray detector, and comparing the recorded pattern of detected x-rays exiting the object containing the combined detection material within a predetermined angular acceptance along a predetermined angle to previously recorded pattern.

In one embodiment of this invention, the method uses a source of x-rays, a device collimating the x-rays within a very narrow angular tolerance (e.g., an order of a few microradians, at least in one plane), a device for selecting and allowing passing of x-rays only within very narrow angular acceptance (e.g., an order of a few microradians, at least in one plane), a detector of x-rays, and a data processor device to record and display the detected pattern and/or automatically compare the detected pattern to a prerecorded one to confirm authenticity.

The embedded material can be made of materials that essentially render the material and/or pattern indistinguishable from the object matrix when inspected by other detection techniques, including visible light, radiowave, ultrasound, and/or conventional x-ray. In one embodiment of this invention, only an x-ray device having the required sensitivity to x-ray refraction and scattering, such as a Diffraction Enhanced X-ray Imaging (DEXI) system, is capable of detecting the embedded material. Exemplary DEXI systems and methods, also generally known as Diffraction Enhanced Imaging (DEI), include, for example, those taught by Chapman et al., U.S. Pat. No. 5,987,095; Chapman et al., U.S. Pat. No. 6,577,708; and Wernick et al., U.S. Pat. No. 7,076,205. The method of this invention can also be used, for example, with the crystal and imaging technology taught by Zhong et al., U.S. Pat. No. 6,038,285. The subject matter of these Patents is hereby incorporated by reference herein in their entirety.

DEXI is a radiographic technique that derives contrast from an object's x-ray absorption, refraction and ultra-small-angle scattering properties. DEXI can be used to detect, analyze, combine and visualize the refraction, absorption and scattering effects upon an image of an object. Compared to the absorption contrast of conventional radiography, the additional contrast mechanisms, refraction, and/or scatter, of DEXI allow visualization of more features of the object, including such that may be invisible for the absorption contrast.

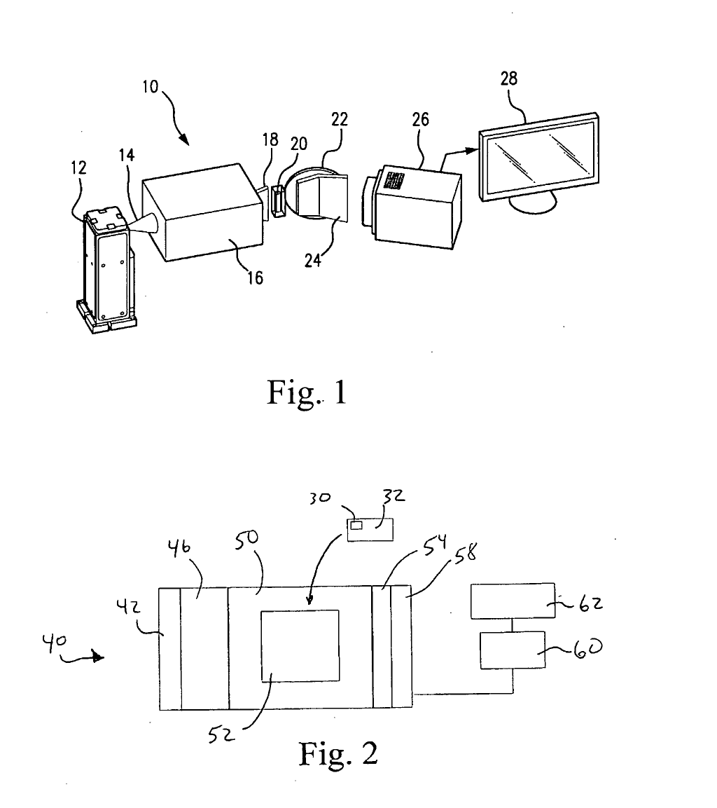

DEXI can use highly collimated x-rays prepared by x-ray diffraction from perfect single-crystal, e.g., silicon. FIG. 1 illustrates a representative DEXI system or apparatus 10 and method of use according to one embodiment of this invention. The apparatus 10 includes a conventional x-ray source 12 for emitting x-rays. The x-rays 14 are passed through a monochromator/collimator 16 to produce collimated x-ray beam 18. These collimated x-rays are of single x-ray energy, practically monochromatic, and are used as the beam to image an object. Further, the collimated x-rays can be prepared by two or more crystals constituting a monochromator. The collimated x-ray beam 18 is passed through object 20. Once this beam passes through the object, another crystal 22 of predetermined crystallographic orientation and using predetermined reflection is introduced. This crystal 22 is commonly called an analyzer. If this analyzer crystal 22 is rotated about an axis orthogonal to the direction of x-ray propagation, the crystal 22 will rotate through a Bragg condition for diffraction and the diffracted intensity of beam 24 will trace out a profile that is called a rocking curve. A detector 26 receives the beam 24 from the analyzer 22, and records and displays the image of object 20 on display 28.

When one image is taken along the rocking curve, absorption, refraction and scatter are present in different proportions depending on the point of the rocking curve chosen. When at least two images are obtained by a detector at different angled positions, for example, one at each of the low and high angle sides of the rocking curve, of the crystal analyzer, the images can be mathematically combined to obtain images, such as separate refraction and absorption images, which both only contain small-angle scattering effects in them, as disclosed in Chapman et al., U.S. Pat. No. 5,987,095. When more than two images are obtained by a detector at different angled positions, for example, one at each of the low and high angle sides of the rocking curve, and one at the peak of the rocking curve, of the crystal analyzer, the images can be mathematically combined to obtain images, such as separate absorption, refraction and small-angle scattering, as disclosed in Wernick et al., U.S. Pat. No. 7,076,205.

In one embodiment of this invention, when the object and the material absorption are matched or essentially similar, the object becomes invisible to conventional x-radiography. The object can be made either invisible or indistinguishable from the detection material when inspected with, e.g., visible light, electromagnetic waves, or ultrasound, thus rendering such other authentication methods useless in identifying the authenticity of the object. In a specific embodiment, a crystal monochromator is used that both collimates and monochromatizes the x-ray beam. Furthermore, a dual-crystal monochromator, including one with mismatched crystals such as disclosed in U.S. Pat. No. 7,330,530, herein incorporated by reference, can be used.

In one embodiment of this invention, one image can be taken at a predetermined point of the rocking curve of the analyzer crystal (i.e., the angular acceptance device after the object), which still contains absorption, refraction and scatter in different proportions depending on the point of the rocking curve chosen, and which can then be recorded and used for comparison purposes. Images thus obtained can be taken at predetermined positions of both the collimator and the analyzer to show features that might be otherwise invisible.

In one embodiment of this invention, two or more images can be taken at different points of the rocking curve of the analyzer crystal (i.e., the angular acceptance device after the object), which can then be combined to construct either a set of two DEXI images, such as according to Chapman et al., U.S. Pat. No. 5,987,095, or with at least three images a MIR DEXI set of images, such as according to Wernick et al., U.S. Pat. No. 7,076,205. Images can be taken at predetermined positions of both the collimator and the analyzer to show features that might be otherwise invisible.

As shown in FIG. 2, a detection material 30, such as in a predetermined pattern, can be applied to object 32. The detection material 30 can be applied on or in the object, such as on a surface of the object or within or between substrates of the object. For example, where the object 32 is an identification card, such as a driver's license or passport, the detection material 30 pattern can be applied between substrate layers of the card. The detection material 30 is desirably applied in a detection pattern, such as, without limitation, an alpha-numeric code, a graphical pattern, a fingerprint pattern, and/or a barcode. For identification cards, a person's actual fingerprint can be applied as the detection pattern 30. The detection material is invisible to the naked eye under the visible light spectrum, and desirably not detectable by common detection techniques such as IR or UV detection, but detectable using x-ray detection based upon x-ray absorption, refraction, and/or scattering using apparatus 40.

Detection apparatus 40 includes components such as described in FIG. 1, within one or more housings to protect the components. As the particular configuration of the components can vary depending on need, the apparatus 40 is representatively shown in FIG. 2. The apparatus 40 includes an x-ray source 42 and a monochromator/collimator 46. A chamber 50 having access 52 receives the object 32. The access 52 can be a door, such as for a larger object, or simply a slot, such as for identification cards. A collimated x-ray beam passes through the object 32 within the chamber 50, and after being reflected by analyzer 54 is transmitted to detector 58. A data processor 60 includes a recordable medium for operating the device 40, and for displaying the recorded image of object 32 with the detection material, such as on GUI 62, which can be a monitor or a handheld device.

The present invention is described in further detail in connection with the following example which illustrates or simulates various aspects involved in the practice of the invention. It is to be understood that all changes that come within the spirit of the invention are desired to be protected and thus the invention is not to be construed as limited by these examples.

### EXAMPLE

To demonstrate the use of the invention a detection material was applied to a plastic identification card and imaged. The detection material was formed from monofilament fishing line applied in a random pattern to the card using double sided tape. The fishing line was obviously visible in this example, but was chosen due to it having a similar absorption to the plastic card to demonstrate the detection methods of this invention.

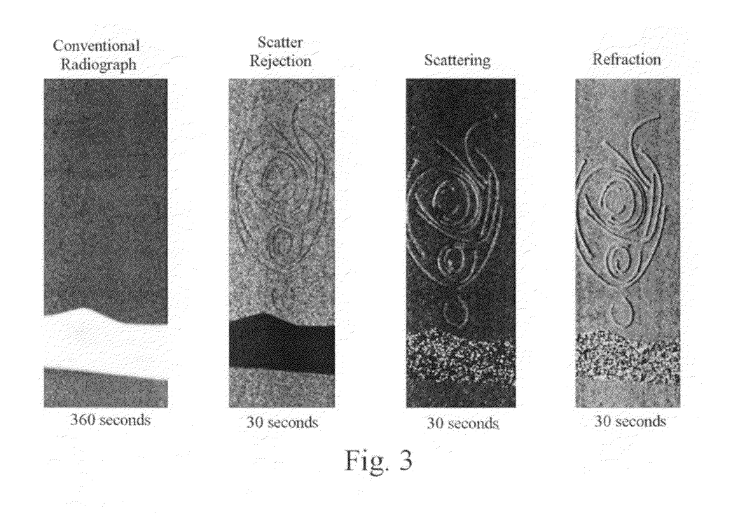

The card with the detection pattern was placed in an imaging chamber of a device having the components as described for FIG. 2. The object was imaged using conventional (non-collimated) x-rays and collimated x-rays according to this invention. FIG. 3 illustrates four images of the card with the detection pattern. The detection pattern was not detected by conventional radiography techniques, using the machine without the analyzer crystal. The detection pattern is seen in the scatter-rejection, scattering, and refraction images obtained using DEXI and MIR imaging techniques. The scatter-rejection image was obtained using a DEXI technique with a single image captured at the height of the rocking curve of the analyzer. The scattering and refraction images of FIG. 3 are each the result of combining multiple images captured at multiple points on each side of the rocking curve.

Thus, the invention provides a method for authenticating objects including a detection material that is indistinguishable from the object by the human eye. The invention can be used to impart a further level of identification security to identification cards or passports, such as by adding a security code or fingerprint of the cardholder for verification purposes.

While in the foregoing description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method for authenticating an object, the method comprising:
providing the object with a detection material that is indistinguishable from the object by the human eye;
traversing collimated x-ray radiation through the object;
detecting x-ray radiation exiting the object;
recording a pattern of the detected x-ray radiation exiting the object; and
confirming the presence of the detection material in the recorded pattern.

2. The method of claim 1, further comprising selecting traversed x-ray radiation through the object within a predetermined angular acceptance along a predetermined angle.

3. The method of claim 1, further comprising comparing the recorded pattern of detected x-rays exiting the object containing the combined detection material within a predetermined angular acceptance along a predetermined angle to a previously recorded pattern of the detection material.

4. The method of claim 1, wherein the detection material comprises a predetermined pattern.

5. The method of claim 1, wherein the detection material is applied on or embedded in the object.

6. The method of claim 1, wherein the detection material comprises a detection pattern selected from an alpha-numeric code, a graphic pattern, a fingerprint pattern, a barcode, or combinations thereof.

7. The method of claim 1, wherein the detection material is indistinguishable from an object matrix when inspected by detection techniques, comprising visible light, radiowave, ultrasound, and/or conventional x-ray.

8. The method of claim 1, further comprising collimating the x-rays within an angular tolerance of less than 90 milliradians in at least one plane.

9. The method of claim 1, further comprising capturing at least two images at different points of a rocking curve of an analyzer crystal and combining the at least two images to construct a final image.

10. The method of claim 1, further comprising repeating the method to obtain at least two images each at one of at least two predetermined positions of at least one of the collimator or the analyzer, and combining the at least two images to obtain a final image.

11. The method of claim 1, further comprising repeating the method to obtain at least three images each at one of at least three predetermined positions of at least one of the collimator or the analyzer, and combining the images to obtain a final image.

12. The method of claim 1, further comprising:
producing x-rays;
collimating the x-rays in at least one plane;
selecting x-rays exiting the object containing the detection material within a predetermined angular acceptance along a predetermined angle;
detecting selected x-rays exiting the object containing the detection material within the predetermined angular acceptance along the predetermined angle by an x-ray detector;
recording a pattern of the detected x-ray exiting the object containing the detection material, and
comparing the recorded pattern of detected x-rays exiting the object containing the detection material to a previously recorded pattern of the detection material.

13. The method of claim 12, further comprising repeating the method to obtain at least two images each at one of at least two predetermined positions of at least one of the collimator or the analyzer, and combining the at least two images to obtain a final image.

14. The method of claim 12, further comprising repeating the method to obtain at least three images each at one of at least three predetermined positions of at least one of the collimator or the analyzer, and combining the images to obtain a final image.

15. The method of claim 12, further comprising capturing a second recorded pattern at a second predetermined angular acceptance along a second predetermined angle and combining the two recorded patterns to construct a final image.

16. A detection apparatus for implementing the traversing, detecting, and recording step of claim 1, the apparatus comprising a collimated x-ray emitter and an x-ray detector.
